(19) United States
(12) Patent Application Publication
(10) Pub. No.: US 2014/0295679 A1
(43) Pub. Date: Oct. 2, 2014

(54) FIXING ASSEMBLY FOR DATA CABLE

(71) Applicants: HONG FU JIN PRECISION INDUSTRY (ShenZhen) CO., LTD., (US); HON HAI PRECISION INDUSTRY CO., LTD., New Taipei (TW)

(72) Inventors: WU ZHOU, Shenzhen (CN); JUN-HUI WANG, Shenzhen (CN); XIAO-GANG YIN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/864,265

(22) Filed: Apr. 17, 2013

(30) Foreign Application Priority Data
Mar. 28, 2013 (CN) 201310103713.6

(51) Int. Cl. H01R 12/70

(52) U.S. Cl. CPC H01R 12/7058
USPC 439/55

(57) ABSTRACT

A fixing assembly for fixing a number of data cables to a motherboard with a number of sockets includes a frame mounted on the motherboard and receiving the sockets, and two blocking members detachably mounted to the frame. The blocking members each include a blocking piece blocking tops of the adjacent connectors, to prevent connectors of the data cables from being disengaged from the corresponding sockets.

### BACKGROUND

1. Technical Field

The present disclosure relates to an assembly for fixing data cable.

2. Description of Related Art

Serial advanced technology attachment (SATA) data cables are often connected to motherboards without fixing structures. As a result, connectors of the data cables may be easily disengaged from the motherboards, which is undesirable.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a fixing assembly, together with a plurality of data cables and a motherboard.

FIG. 2 is an assembled, isometric view of FIG. 1.

FIG. 3 is a cross-sectional view of FIG. 2, taken along the line III-III.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

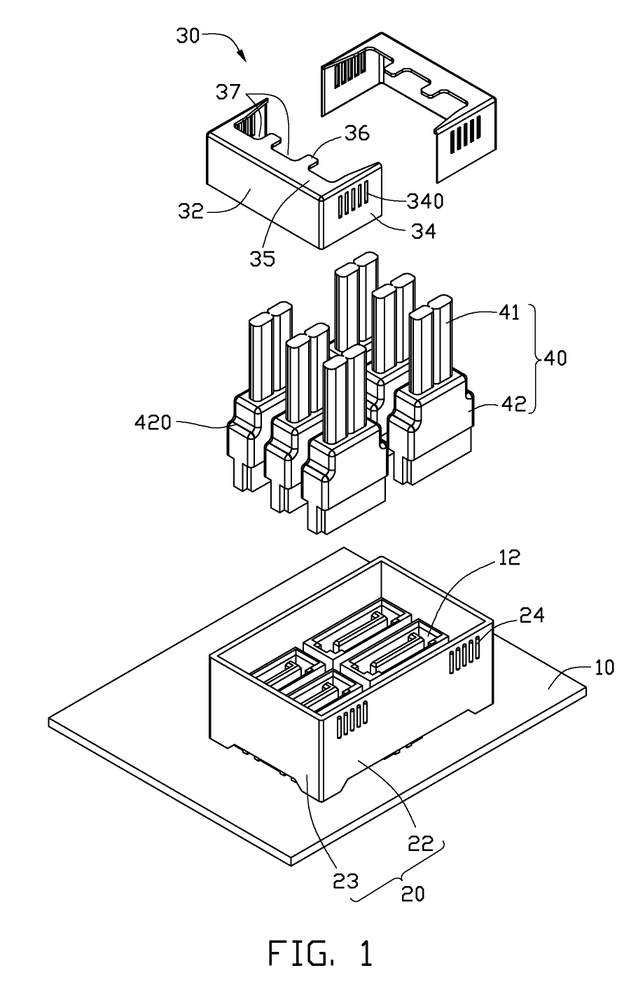

FIG. 1 is an exemplary embodiment of a fixing assembly for fixing data cables 40. The fixing assembly includes a hollow and substantially rectangular frame 20 mounted to a motherboard 10, and two blocking members 30.

Each data cable 40 includes a cable 41 and a connector 42 connected to an end of the cable 41. Each connector 42 includes two blocking surfaces 420 at opposite ends of a top wall of the connector 42. In this embodiment, the blocking surfaces 420 of each connector 42 are lower than a center of the top wall of the connector 42 adjacent to the cable 41.

A plurality of sockets 12 is mounted on the motherboard 10 to electrically receive the connectors 42.

The frame 20 includes two opposite sidewalls 22 and two opposite end walls 23 connected between opposite ends of the sidewalls 22. A plurality of protrusions 24 protrudes from an outer surface of each of opposite ends of each sidewall 22. The frame 20 is mounted on the motherboard 10 and receives the sockets 12.

Each blocking member 30 includes a connecting piece 32, two arms 34 perpendicularly extending from opposite ends of the connecting piece 32, and a blocking piece 35 perpendicularly extending from a top side of the connecting piece and connected to top sides of the arms 34. A length of the blocking piece 35 is less than a length of the arms 34 in the extension direction of the arms 34. A plurality of tabs 36 extends from an inner side of the blocking piece 35 away from the connecting piece 32, coplanar with the blocking piece 35. A slot 37 is defined between every two adjacent tabs 36 or each outmost tab and the corresponding arm 34. Each arm 34 defines a plurality of through holes 340, arranged in a row along the extension direction of the arm 34.

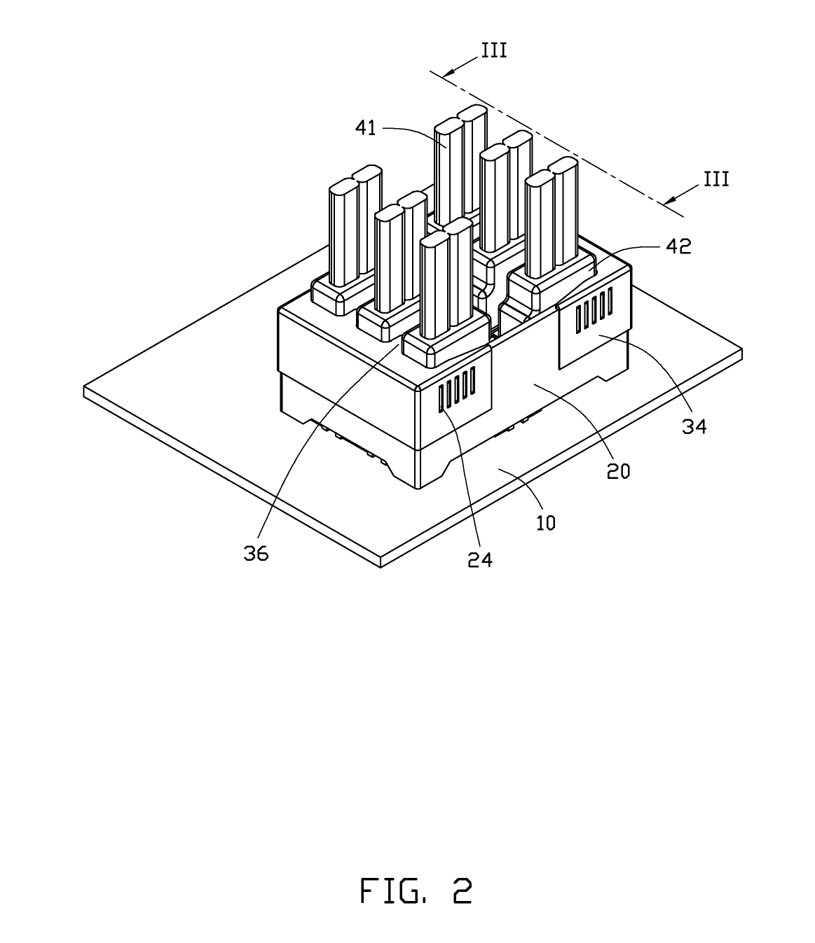

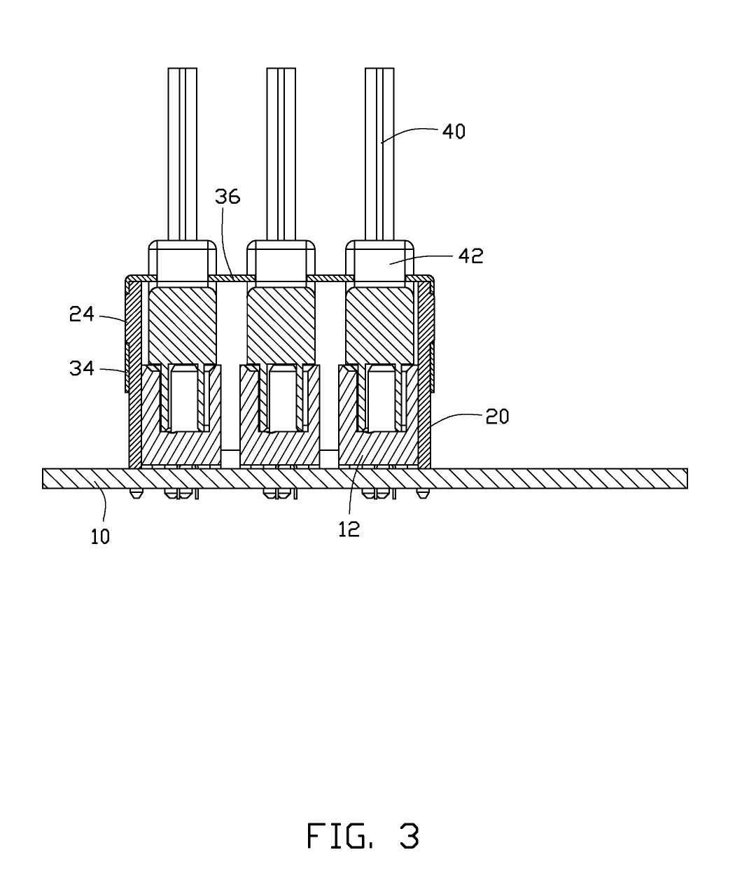

FIGS. 2 and 3 show that in assembly, the connectors 42 are plugged into the sockets 12. The blocking members 30 are mounted to opposite ends of the frame 20. The connecting pieces 32 abut against outer surfaces of the end walls 23. The protrusions 24 are detachably engaged in the corresponding through holes 340. The blocking pieces 35 are supported on outmost blocking surfaces 420 of the connectors 42. The cables 41 extend out through the corresponding slots 37.

In another embodiment, the blocking surfaces 420 and the tabs 36 can be omitted. The top walls of each connector 42 can be a flat surface. Each blocking piece 35 is supported on the top walls of the adjacent connectors 42.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A fixing assembly for fixing data cables comprising connectors which are engaged with sockets mounted on a motherboard, the fixing member comprising:
a frame mounted on the motherboard and receiving the sockets; and
two blocking members mounted to opposite ends of the frame, each blocking member comprising a blocking piece to block top walls of the connectors.

2. The assembly of claim 1, wherein a plurality of tabs extends from each blocking piece, a slot is defined between every two adjacent tabs, through which a data cable extends out.

3. The assembly of claim 2, wherein the plurality of tabs is coplanar with the blocking pieces.

4. The assembly of claim 1, wherein the frame comprises two opposite sidewalls and two opposite end walls connected between the sidewalls; each blocking member comprises a connecting piece abutted against an outer surface of one of the end walls, two arms extending from opposite ends of the connecting piece to be detachably fixed to the sidewalls; and the blocking piece of each blocking member is connected among top sides of the connecting piece and the arms.

5. The assembly of claim 4, wherein each arm defines at least one through hole, at least two protrusions protrude from each sidewall of the frame to be engaged in the corresponding through holes of the arms.
